(19) United States
(12) Patent Application Publication
(10) Pub. No.: US 2025/0369910 A1
(43) Pub. Date: Dec. 4, 2025

(54) ELECTRICAL SENSING TECHNIQUES USING ALTERNATING CURRENT CARRIER AND MODULATION FREQUENCIES

(71) Applicant: NanoDX, Inc., Southborough, MA (US)

(72) Inventors: Farhad Khosravi, Boston, MA (US); Matthew Lawrence Elani, Cambridge, MA (US); John E. Kelly, III, Poughquag, NY (US); Piper Katharine O'Donnell, Brookline, MA (US); William Paul Blomerth, Brighton, MA (US); Suraj Kethan Puvvada, Cary, NC (US)

(73) Assignee: NanoDX, Inc., Southorough, MA (US)

(21) Appl. No.: 19/224,390

(22) Filed: May 30, 2025

Related U.S. Application Data
(60) Provisional application No. 63/654,405, filed on May 31, 2024.

(51) Int. Cl. G01N 27/22

(52) U.S. Cl. CPC G01N 27/227

(57) ABSTRACT

Described herein are techniques that, in some embodiments, bias a sensor using an alternating current (AC) signal having a carrier frequency and a modulation frequency to detect the presence of matter proximate the sensor. In some embodiments, an AC current flowing in the sensor may be measured to detect the presence of matter proximate the sensor. In some embodiments, the carrier frequency may be based on an electrochemical interface at a surface of the sensor, and the modulation frequency may be based on a characteristic of a semiconductor channel of the sensor. Advantageously, detection techniques performed in this manner may, in some embodiments, mitigate impacts of the electrochemical interface and/or the semiconductor channel on measurement accuracy.

### RELATED APPLICATIONS

This application claims priority under 35 U.S.C. § 119(e) to U.S. Provisional Application No. 63/654,405, filed May 31, 2024, and entitled “ELECTRICAL SENSING TECHNIQUES USING CHANGE IN CAPACITANCE,” which is incorporated herein by reference in its entirety for all purposes.

### FIELD

The present application relates generally to systems, devices, and methods for detecting the presence of matter proximate a surface of a sensor, and, more particularly, to systems, devices, and methods suitable for detecting matter in a fluid proximate a surface of a sensor.

### BACKGROUND

Sensors may be employed to detect one or more features of a fluid (e.g., a bodily fluid). One manner in which features may be detected is using measurement circuitry coupled to a sensor, which may detect features based on electrical characteristics of the sensor. However, some sensors have undesirably low sensitivity to features of interest, which can result in signals being provided to the measurement circuitry that are too weak to be useful for detecting features. Accordingly, improved sensing systems, devices, and methods are needed.

### BRIEF SUMMARY

Electrical sensing techniques and related sensors, systems, and methods are generally described.

Some embodiments of the present disclosure relate to a method of detecting matter proximate a sensor. The method may comprise biasing a control terminal of the sensor with a voltage signal, measuring a current flowing through a semiconductor channel of the sensor in response to the voltage signal being applied to the control terminal, and determining, using the current, a capacitance of the sensor indicative of the matter at a surface of the sensor.

In some embodiments, the method may further comprise biasing the sensor with an AC voltage signal, the current may comprise an AC current flowing in response to the sensor being biased with the AC voltage signal, and the AC current may indicate the capacitance.

In some embodiments, determining the capacitance of the sensor may comprise obtaining, using the current, a transconductance of the sensor.

In some embodiments, the transconductance of the sensor may indicate a change in transconductance of the sensor with respect to a second transconductance of the sensor without the matter at the surface, and determining the capacitance may comprise obtaining a change in capacitance, with respect to a second capacitance of the sensor without the matter at the surface, from the change in transconductance.

In some embodiments, the capacitance may be indicative of a change in dielectric constant at the surface of the sensor, and the change in dielectric constant at the surface of the sensor may indicate the matter at the surface of the sensor.

In some embodiments, the sensor may comprise a control stack comprising the surface and a dielectric layer between the surface and the semiconductor channel, and the change in dielectric constant may be from a first dielectric constant of the control stack without the matter at the surface to a second dielectric constant of the control stack further including the matter present at the surface.

In some embodiments, the sensor may further comprise a pair of channel terminals coupled to the semiconductor channel, and the current flows between the pair of channel terminals.

In some embodiments, a medium may be disposed on the surface of the sensor and comprises the matter.

Some embodiments of the present disclosure relate to a system. The system may comprise a sensor, comprising a control terminal, a semiconductor channel, and a surface, and the system may further comprise circuitry configured to bias the control terminal with a voltage signal, measure a current flowing through the semiconductor channel in response to the voltage signal being applied to the control terminal, and determine, using the current, a capacitance of the sensor indicative of matter at the surface of the sensor.

In some embodiments, the circuitry may be further configured to bias the semiconductor channel with an AC voltage signal, the current may comprise an AC current flowing in response to the semiconductor channel being biased with the AC voltage signal, and the AC current may indicate the capacitance.

In some embodiments, the circuitry may be configured to determine the capacitance of the sensor at least in part by obtaining, using the current, a transconductance of the sensor.

In some embodiments, the transconductance of the sensor may indicate a change in transconductance of the sensor with respect to a second transconductance of the sensor without the matter at the surface, and the circuitry may be configured to determine the capacitance at least in part by obtaining a change in capacitance, with respect to a second capacitance of the sensor without the matter at the surface, from the change in transconductance.

In some embodiments, the capacitance may be indicative of a change in dielectric constant at the surface of the sensor, and the change in dielectric constant at the surface of the sensor may indicate the matter at the surface of the sensor.

In some embodiments, the sensor may comprise a control stack comprising the surface and a dielectric layer between the surface and the semiconductor channel, and the change in dielectric constant may be from a first dielectric constant of the control stack without the matter at the surface to a second dielectric constant of the control stack further including the matter present at the surface.

In some embodiments, the sensor may further comprise a pair of channel terminals coupled to the semiconductor channel, and the current may flow between the pair of channel terminals.

Some embodiments of the present disclosure relate to a system. The system may comprise a sensor comprising a pair of channel terminals, a semiconductor channel coupled to and between the pair of channel terminals, and a control stack comprising a dielectric layer and a surface, with the dielectric layer between the surface and the semiconductor channel, and the system may further comprise circuitry coupled to the sensor and configured to measure current flowing between the pair of channel terminals and, using the current, detect a capacitance of the sensor, the capacitance being indicative of matter present at the surface.

In some embodiments, the sensor may further comprise a control terminal separated from the semiconductor channel by the control stack, and the circuitry may be configured to bias the control terminal and measure the current flowing in the semiconductor channel in response to biasing the control terminal, the current being indicative of the capacitance.

In some embodiments, the circuitry may be further configured to bias the sensor with an AC voltage, and the current comprises an AC current flowing between the pair of channel terminals in response to the sensor being biased with the AC voltage.

In some embodiments, the current may be indicative of a change in transconductance of the sensor with respect to a second transconductance of the sensor without the matter present at the surface, and the change in transconductance may be indicative of a change in capacitance with respect to a second capacitance of the sensor without the matter present at the surface.

In some embodiments, the capacitance may be indicative of a change in dielectric constant of the control stack with respect to without the matter present at the surface.

In some embodiments, the change in dielectric constant may be from a first dielectric constant of the control stack without the matter present at the surface to a second dielectric constant of the control stack further including the matter present at the surface of the sensor.

In some embodiments, the capacitance may be between the control terminal and the semiconductor channel.

Some embodiments of the present disclosure relate to a method of detecting matter proximate a sensor. The method may comprise measuring current flowing between a pair of channel terminals of the sensor and, using the current, detecting a capacitance of the sensor, the capacitance being indicative of matter present at a surface of the sensor, and the sensor may comprise a semiconductor channel coupled to and between the pair of channel terminals and a control stack, the control stack comprising the surface and the control stack further comprising a dielectric layer between the surface and the semiconductor channel.

In some embodiments, the sensor may further comprise a control terminal separated from the semiconductor channel by the dielectric layer, the method may further comprise biasing the control terminal, the current may flow in the semiconductor channel in response to biasing the control terminal, and the current may be indicative of the capacitance.

In some embodiments, the capacitance may be between the control terminal and the semiconductor channel.

In some embodiments, the method may further comprise biasing the sensor with an AC voltage, and the current may comprise an AC current flowing between the pair of channel terminals in response to the sensor being biased with the AC voltage.

In some embodiments, the current may be indicative of a change in transconductance of the sensor with respect to a second transconductance of the sensor without the matter present at the surface, and the change in transconductance may be indicative of a change in capacitance with respect to a second capacitance of the sensor without the matter present at the surface.

In some embodiments, the capacitance may be indicative of a change in dielectric constant of the control stack with respect to without the matter present at the surface.

In some embodiments, the change in dielectric constant may be from a first dielectric constant of the control stack without the matter present at the surface to a second dielectric constant of the control stack further including the matter present at the surface.

In some embodiments, a medium may be disposed on the surface of the sensor and comprises the matter.

Some embodiments of the present disclosure relate to a method of detecting matter proximate a sensor. The method may comprise biasing a control terminal of the sensor with a voltage signal, measuring a current flowing through a semiconductor channel of the sensor in response to the voltage signal being applied to the control terminal, and determining, using the current, a change in transconductance of the sensor indicative of the matter at a surface of the sensor.

In some embodiments, the method may further comprise biasing the sensor with an AC voltage signal, wherein the current comprises an AC current flowing in response to the sensor being biased with the AC voltage signal, and the AC current indicates the change in transconductance.

In some embodiments, the change in transconductance of the sensor may be with respect to a second transconductance of the sensor without the matter at the surface.

In some embodiments, the method may further comprise obtaining, from the change in transconductance, a change in capacitance of the sensor with respect to a second capacitance of the sensor without the matter at the surface.

In some embodiments, the change in capacitance may be indicative of a change in dielectric constant at the surface of the sensor, and the change in dielectric constant at the surface of the sensor indicates the matter at the surface of the sensor.

In some embodiments, the sensor may comprise a control stack comprising the surface and a dielectric layer between the surface and the semiconductor channel, and the change in dielectric constant is from a first dielectric constant of the control stack without the matter at the surface to a second dielectric constant of the control stack further including the matter present at the surface.

In some embodiments, the sensor may further comprise a pair of channel terminals coupled to the semiconductor channel, and the current flows between the pair of channel terminals.

In some embodiments, a medium may be disposed on the surface of the sensor and comprise the matter.

Some embodiments of the present disclosure relate to a method of detecting matter, in a medium, disposed proximate a surface of a sensor. The method may comprise biasing a semiconductor channel of the sensor with an alternating current (AC) signal, the AC signal having a carrier frequency, based on an electrochemical interface between the medium and a surface of the sensor, and the AC signal further having a modulation frequency based on an electrical characteristic of the semiconductor channel, measuring AC current flowing through the semiconductor channel of the sensor in response to biasing the semiconductor channel with the AC signal, and determining, based on the AC current, a presence of matter, in the medium, disposed proximate the surface.

In some embodiments, the method may further comprise generating the AC signal by mixing a modulation signal having the modulation frequency with a carrier signal having the carrier frequency.

In some embodiments, the carrier frequency may be above a high-pass cutoff frequency of the electrochemical interface that is based on a diffusion impedance and a double-layer capacitance of the electrochemical interface.

In some embodiments, the modulation frequency may be below a threshold frequency of the semiconductor channel that is based on gate-to-channel leakage of the semiconductor channel.

In some embodiments, determining the presence of matter proximate the surface may comprise determining, based on the AC current, a change in transconductance from a first transconductance without the matter present to a second transconductance with the matter present.

In some embodiments, determining the presence of matter proximate the surface may comprise determining, based on the AC current, a change in capacitance from a first capacitance without the matter present to a second capacitance with the matter present.

In some embodiments, the change in capacitance may be indicative of a change in dielectric constant at the surface of the sensor, and the change in dielectric constant at the surface of the sensor indicates the matter at the surface of the sensor.

In some embodiments, the sensor may comprise a control stack comprising the surface and a dielectric layer between the surface and the semiconductor channel, and the change in dielectric constant is from a first dielectric constant of the control stack without the matter at the surface to a second dielectric constant of the control stack further including the matter present at the surface.

In some embodiments, the sensor may further comprise a pair of channel terminals coupled to the semiconductor channel, and the AC current flows between the pair of channel terminals.

In some embodiments, the method may further comprise determining, using the capacitance of the sensor, a presence of a species in the matter at the surface of the sensor.

In some embodiments, the method may further comprise determining, using the change in transconductance of the sensor, a presence of a species in the matter at the surface of the sensor.

In some embodiments, determining the presence of matter in the medium disposed proximate the surface may comprise determining a presence of a species in the matter at the surface of the sensor.

In some embodiments, determining the presence of the species in the matter at the surface of the sensor may comprise determining an amount of the species in the matter at the surface of the sensor.

In some embodiments, the capacitance may indicate the amount of the species in the matter at the surface of the sensor.

In some embodiments, the capacitance may indicate the amount of the species in the matter as bound to the surface of the sensor.

In some embodiments, the species may be organic.

In some embodiments, the species may be a protein.

In some embodiments, the species may be a biomarker.

In some embodiments, the biomarker may be a biomarker for brain injury.

In some embodiments, the species may be selected from a group consisting of: GFAP, S100B, UCH-L1, and NFL-1.

In some embodiments, determining the presence of the species may comprise determining whether the species is bound to the surface of the sensor.

In some embodiments, the surface of the sensor may comprise a molecule that selectively binds to the species.

In some embodiments, the method may further comprise depositing a fluid comprising the species on the surface of the sensor.

In some embodiments, the fluid may comprise bodily fluid.

In some embodiments, the bodily fluid may be selected from a group consisting of: blood, plasma, saliva, tears, urine, nasal fluid, and nasopharyngeal fluid.

In some embodiments, depositing the fluid on the surface of the sensor may cause the species to bind to the surface of the sensor.

In some embodiments, an amount of the species that binds to the surface of the sensor may be based on an amount and/or concentration of the species in the fluid.

Some embodiments of the present disclosure relate to a system. The system may comprise a sensor. The sensor may comprise a semiconductor channel and a surface. The system may further comprise circuitry configured to, while matter in a medium is disposed proximate the surface of the sensor, bias the semiconductor channel of the sensor with an alternating current (AC) signal, the AC signal having a carrier frequency, based on an electrochemical interface between the medium and the surface of the sensor, and the AC signal further having a modulation frequency based on an electrical characteristic of the semiconductor channel, measure AC current flowing through the semiconductor channel of the sensor in response to biasing the semiconductor channel with the AC signal, and determine, based on the AC current, a presence of matter, in the medium, disposed proximate the surface.

In some embodiments, the circuitry may be further configured to generate the AC signal by mixing a modulation signal having the modulation frequency with a carrier signal having the carrier frequency.

In some embodiments, the carrier frequency may be above a high-pass cutoff frequency of the electrochemical interface that is based on a diffusion impedance and a double-layer capacitance of the electrochemical interface.

In some embodiments, the modulation frequency may be below a threshold frequency of the semiconductor channel that is based on gate-to-channel leakage of the semiconductor channel.

In some embodiments, the circuitry may be configured to determine the presence of matter proximate the surface at least in part by determining, based on the AC current, a change in transconductance from a first transconductance without the matter present to a second transconductance with the matter present.

In some embodiments, the circuitry may be configured to determine the presence of matter proximate the surface at least in part by determining, based on the AC current, a change in capacitance from a first capacitance without the matter present to a second capacitance with the matter present.

In some embodiments, the change in capacitance may be indicative of a change in dielectric constant at the surface of the sensor, and the change in dielectric constant at the surface of the sensor indicates the matter at the surface of the sensor.

In some embodiments, the sensor may comprise a control stack comprising the surface and a dielectric layer between the surface and the semiconductor channel, and the change in dielectric constant is from a first dielectric constant of the control stack without the matter at the surface to a second dielectric constant of the control stack further including the matter present at the surface.

In some embodiments, the sensor may further comprise a pair of channel terminals coupled to the semiconductor channel, and the AC current flows between the pair of channel terminals.

Other advantages and features of the present disclosure will become apparent from the following detailed description of various non-limiting embodiments of the disclosure when considered in conjunction with the accompanying figures. In cases where the present application and a document incorporated by reference include conflicting and/or inconsistent disclosure, the present disclosure shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a block diagram of an example system for detecting matter at a surface of a sensor, according to some embodiments;

FIG. 2 is a schematic view of an example sensor in a configuration for measuring a change in capacitance of the sensor indicative of matter at a surface of the sensor, according to some embodiments;

FIG. 3 is a graph of current through a semiconductor channel of a sensor vs. voltage applied to a control terminal of the sensor for a sweep of applied control terminal voltages, according to some embodiments;

FIG. 4 is a graph of current through a semiconductor channel of a sensor vs. voltage applied to a control terminal of the sensor for a plurality of sweeps of applied control terminal voltages corresponding to a plurality of capacitance states of the sensor, according to some embodiments;

FIG. 5 is a circuit diagram of example sensor biasing and measurement circuitry that may be used in a system described herein, according to some embodiments;

FIG. 6 is a flow diagram of an example method of operating a sensor to detect matter at a surface of the sensor using a change in capacitance of the sensor, according to some embodiments;

FIG. 7 is a circuit diagram modeling an example electrochemical interface at a surface of a sensor, according to some embodiments;

FIG. 8 is an annotated graph of quality factor (Q) over frequency for AC signals used to bias the semiconductor channel of the sensor of FIG. 7, according to some embodiments;

FIG. 9A is a graph of voltage over time for an example AC signal that may be used to bias the semiconductor channel of the sensor of FIG. 7, according to some embodiments;

FIG. 9B is a graph of current over time for the example AC signal of FIG. 9A, according to some embodiments;

FIG. 10 is a graph of AC signal amplitude over frequency for the example AC signal of FIG. 9A, according to some embodiments;

FIG. 11 is a graph of measured percentage change in transconductance over frequency for an example sensor, according to some embodiments;

FIG. 12A is a cross-section of an example sensor with solution proximate a surface of the sensor, the surface being treated to bind antigens in the solution to the surface, according to some embodiments;

FIG. 12B is a cross-section of another example sensor in a similar configuration to the sensor of FIG. 12A, further illustrating a gate terminal on a common substrate with the channel and other terminals, according to some embodiments;

FIG. 13A is a graph of transconductance (Gm) vs. gate voltage for a FET-based sensor obtained from current measured from the sensor in response to a DC voltage bias applied to the sensor, according to some embodiments;

FIG. 13B is a graph of transconductance vs. gate voltage for the FET-based sensor of FIG. 13B obtained from current measured from the sensor in response to an AC voltage bias applied to the sensor, according to some embodiments;

FIG. 14A is a graph of normalized current measured from the sensor of FIG. 13A in response to the DC voltage bias, according to some embodiments;

FIG. 14B is a graph of normalized current measured from the sensor of FIG. 13B in response to the AC voltage bias, according to some embodiments;

FIG. 15A is a graph of current vs. time for current measured from a FET-based sensor in multiple states of the sensor, according to some embodiments;

FIG. 15B is a graph of material thickness vs. time for current measured from the FET-based sensor of FIG. 15A in the multiple states of the sensor, according to some embodiments;

FIG. 15C illustrates measured change in gate threshold voltage of a FET-based sensor during two experiments similar to the experiments of FIGS. 15A-15B, according to some embodiments;

FIG. 16 illustrates normalized change in signal over a range of concentrations of Bt-BSA applied to a surface of a FET-based sensor, according to some embodiments; and

FIG. 17 is a block diagram of example processing circuitry that may be configured to perform at least some processing operations described herein for the system of FIG. 1, in accordance with some embodiments.

### DETAILED DESCRIPTION

### Introduction

The inventors have recognized drawbacks of previous approaches for electrical sensing using semiconductor channel-based devices (e.g., field-effect transistors (FETs)) that measure either change in conductance of the sensor or change in gate threshold voltage of the sensor (e.g., due to change in surface charge on the gate of a FET) as an indication of certain matter detected to be proximate to the sensor. Previous approaches may produce undetectably low signals and further may be susceptible to various sources of noise. In some previous approaches, charge buildup at a surface of the sensor (e.g., a control stack surface such as a FET gate stack surface) may produce a conductance of the sensor or a change in gate threshold voltage of the sensor, which may be measured to detect binding of matter to the surface (e.g., an analyte in a biosensing application). However, a significant amount of charge may need to build up on the surface to produce a large enough impact on conductance or gate threshold voltage to be detectable using measurement circuitry. Moreover, noise charge that does not indicate the presence of the matter to be detected may also accumulate at the surface and thus distort detection performed using a previous approach. For instance, charge may build up on the surface due to ions sporadically interacting with the surface, such as due to a change in pH of a medium disposed on the surface (e.g., solution in which the presence of matter is desired to be detected), and/or stray charges floating in the medium proximate the sensor (e.g., in which the presence of matter is desired to be detected).

To overcome these drawbacks, the inventors developed techniques that, in some embodiments, leverage capacitance or transconductance of a sensor (e.g., between a control terminal and a semiconductor channel of the sensor) to indicate the presence of matter proximate the sensor. Such techniques may be less susceptible or even entirely immune to some sources of noise that would impact detection of charge buildup on a control stack surface. Some aspects of the present disclosure leverage the inventors' discovery that buildup of matter at a sensor surface may impact capacitance or transconductance between a control terminal of the sensor (e.g., used to bias a control stack that includes the sensor surface) and a semiconductor channel of the sensor, such as by impacting the dielectric constant of material between the control terminal and the semiconductor channel. Advantageously, noise charges may contribute less or not at all to such capacitance or transconductance, such as by having less or no impact on the dielectric constant. As such, in some embodiments, measuring capacitance or transconductance of the sensor may provide a more accurate indication of buildup of matter at a sensor surface than a detection of charge buildup (e.g., using previous approaches for conductance or gate threshold voltage measurement).

In accordance with some aspects of the present disclosure, techniques described herein may include measuring current flowing between a pair of channel terminals of a sensor and, using the current, detecting a capacitance of the sensor, the capacitance being indicative of matter present at a surface of the sensor. For example, the sensor may have a semiconductor channel coupled to and between the pair of channel terminals, and a control stack including the surface and further including a dielectric layer between the surface and the semiconductor channel. For instance, matter being present (e.g., analytes being bound) at the surface of the sensor may impact the capacitance of the control stack (e.g., as compared to without that matter being present), such as from a first capacitance that is set substantially by the dielectric layer (e.g., without the matter present at the surface) to a second capacitance that further takes into account matter present at the surface (e.g., analytes bound to the surface). According to various embodiments, detection of matter built up on the surface may occur over time by determining a change in capacitance over time, and/or detection of matter may be determined with respect to a baseline capacitance corresponding to when the matter being detected is not present on the surface. By detecting matter using capacitance of a sensor, in some embodiments, matter may be more accurately detected due to immunity to at least some sources of noise that may contribute less or not at all to capacitance of the sensor.

In accordance with some aspects of the present disclosure, techniques described herein may include biasing a control terminal of a sensor with a voltage signal, measuring a current flowing through a semiconductor channel of the sensor in response to the voltage signal being applied to the control terminal, and determining, using the current, a capacitance of the sensor indicative of matter present at a surface of the sensor. For example, the capacitance may be obtained from the current, such as where the current (e.g., together with the voltage signal) indicates a transconductance of the sensor, which may have a relationship to the capacitance (e.g., control terminal to semiconductor channel capacitance). For instance, the surface at which the matter is present may be located close enough to the semiconductor channel (e.g., at a control stack of the sensor) that the matter contributes to the dielectric constant of material between the control terminal and the semiconductor channel, thereby contributing to the capacitance therebetween, and, in turn, contributing to the transconductance of the sensor (e.g., proportionally).

In some embodiments, a control terminal of a sensor may be controllably biased such that a transconductance may be obtained from the known control terminal voltage and measured current through a channel of the sensor, which in turn may indicate capacitance between the control terminal and the channel. For example, the control terminal may be configured to bias a control stack of the sensor via a medium proximate a control stack of the sensor, and matter within the medium may build up on a surface of the control stack, such that the matter may be detected using its impact on capacitance of the sensor. For instance, measured current in a semiconductor channel of the sensor may indicate a transconductance of the sensor, and the transconductance may indicate a capacitance of the sensor (e.g., between the control terminal and the channel), which in turn may be used to detect the matter built up at a surface of the sensor.

In some embodiments, matter to be detected using capacitance or transconductance may be distinguished from other matter (e.g., a surrounding fluid) based on its relatively greater impact on capacitance or transconductance of the sensor. In a non-limiting example, analytes binding to a surface of a sensor may present a dielectric mass that impacts capacitance or transconductance of the sensor, whereas fluid containing the analytes may present little to no dielectric mass, thereby having little to no impact on capacitance or transconductance of the sensor). According to various embodiments, capacitance may be determined as a value, and/or capacitance may be determined with respect to another capacitance as a change in capacitance, and/or such a determination may be leveraged (e.g., indirectly) within a determination of thickness of material buildup using the impact of material buildup on capacitance, depending on the particular implementation. Similarly, transconductance may be determined as a value and/or with respect to another transconductance as a change in capacitance.

In accordance with some aspects of the present disclosure, techniques described herein may include biasing a semiconductor channel of a sensor with an AC signal having a carrier frequency and a modulation frequency, measuring AC current flowing through the semiconductor channel in response, and determining a presence of matter (e.g., a species, such as a chemical and/or biological species) disposed proximate a surface of the sensor using the AC current (e.g., using a capacitance and/or change in transconductance). For example, the carrier frequency may be based on an electrochemical interface between a medium in which the matter is disposed and the surface of the sensor, and/or the modulation frequency may be based on an electrical characteristic of the semiconductor channel. Biasing the sensor with an AC signal having both a carrier frequency and a modulation frequency, in some embodiments, improves measured signal strength (e.g., reflected in changes in the AC current) by addressing detrimental impacts occurring in different frequency ranges at the electrochemical interface and in the semiconductor channel of the sensor, respectively.

According to various embodiments, the carrier frequency of the AC signal may be above a high-pass cutoff frequency of the electrochemical interface that is based on a diffusion impedance and a double-layer capacitance of the interface. For example, exceeding the high-pass cutoff frequency of the electrochemical interface may overcome at least some detrimental impacts on signal quality due to diffusion of ions at frequencies lower than the high-pass cutoff frequency. According to various embodiments, the modulation frequency of the AC signal may be below a threshold frequency of the semiconductor channel of the sensor that is based on gate-to-channel leakage of the semiconductor channel. For example, the modulation frequency of the AC signal may overcome at least some detrimental impacts on signal quality due to leakage of the AC current flowing in the semiconductor channel (e.g., leaking through the electrochemical interface).

In some embodiments, matter may be detected at (e.g., in direct contact with and/or within 30 nanometers (nm)) of the control stack surface, such as within 20 nm and/or between 3-20 nm from the control stack surface (e.g., of an outermost oxide layer). In some embodiments, changes in matter thickness may be detected at a resolution on the order of picometers.

### Overview of Electrical Sensing Techniques Using Capacitance and/or Transconductance

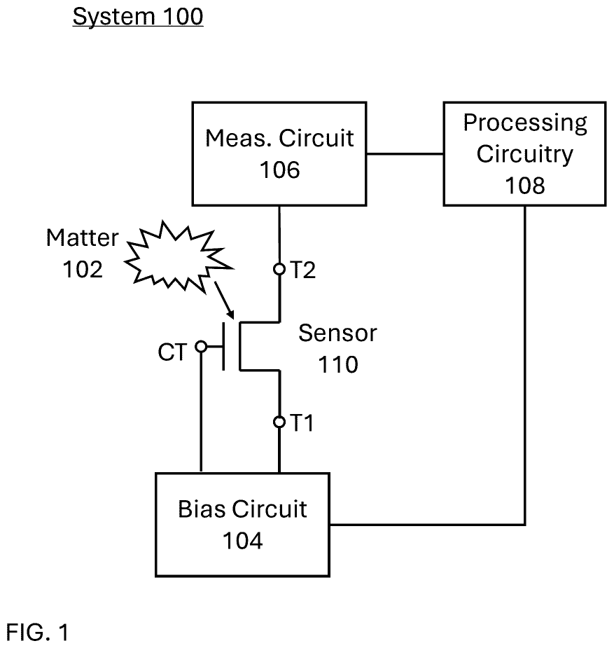

FIG. 1 is a block diagram of an example system 100 for detecting matter 102 (e.g., a species, such as a chemical and/or biological species) at a surface of a sensor 110, according to some embodiments.

As shown in FIG. 1, the example system 100 includes a sensor 110 having a control terminal CT and a pair of channel terminals T1, T2. In some embodiments, the sensor 110 may have a semiconductor channel coupled to and between the pair of channel terminals. For example, in the illustrated embodiment, the sensor 110 may be configured as a FET-based sensor, with the control terminal CT being a gate and the channel terminals T1, T2 being drain and source terminals, respectively. It should be appreciated that sensors having other configurations (e.g., based on other transistor configurations) may be used in other embodiments.

In some embodiments, the system 100 may be configured to detect matter at a surface of the sensor 110. For example, in FIG. 1, the sensor 110 is shown with matter 102 electrically coupled between the control terminal CT of the sensor 110 and the channel, such as providing a separation (e.g., conductive isolation) between the control terminal CT and the channel, such as to form a metal-insulator-semiconductor (MIS) capacitance. For instance, the sensor 110 may be proximate a medium (e.g., fluid) in which the matter 102 to be detected is present, such as where the matter 102 includes analytes or other species and the medium is a liquid. In other instances, the medium may be a vapor or gas, such as where the sensor is used in a breathalyzer configuration. In some cases, the matter 102 within the medium may be distinguished from the medium itself based on the impact on sensor capacitance of buildup of the matter 102 on the surface of the sensor 110, such as where the medium has little to no relative impact on capacitance.

In some embodiments, the system 100 may be configured to bias the sensor 110 with a voltage, measure current flowing through the sensor 110 in response to the voltage bias, and determine, using the current, a capacitance of the sensor 110 indicative of matter 102 at the surface of the sensor 110. For example, as shown in FIG. 1, the example system 100 further includes a bias circuit 104, a measurement circuit 106, and processing circuitry 108, which may be further configured as a controller. For instance, the bias circuit 104 may be configured to apply a voltage bias to the control terminal CT of the sensor 110, the measurement circuit 106 may be configured to measure current flowing through the sensor 110 in response to the voltage bias, and the processing circuitry 108 may be configured to detect matter 102 at a surface of the sensor 110 using the measured current, which measured current may indicate capacitance as described herein. In some embodiments, the processing circuitry 108 may be further configured as a controller, such as to control the bias circuit 104. For example, the processing circuitry 108 may have, as a result of controlling the bias circuit 104, a known value of voltage applied to the control terminal CT which may be used together with the measured current to determine a capacitance of the sensor 110, such as using a transconductance of the sensor 110.

In some embodiments, the bias circuit 104 and the measurement circuit 106 may be implemented together, such as to further bias the sensor 110 (e.g., at a channel terminal T2) with a voltage that creates a voltage drop across the sensor 110, which may cause current to flow in the channel of the sensor 110. For instance, an AC voltage may be applied to the sensor 110, and current flowing in the sensor 110 may include AC current (e.g., at least an AC component of current in the sensor) that the measurement circuit may measure to determine a capacitance of the sensor 110 (e.g., using a change in transconductance using the measured current). In the illustrated embodiment, the bias circuit 104 may be further configured to apply a voltage to a channel terminal T1 of the sensor 110, such as a ground reference. In other embodiments, a ground reference may be applied by the measurement circuit 106 or by the bias circuit 104 and the measurement circuit together, depending on the implementation.

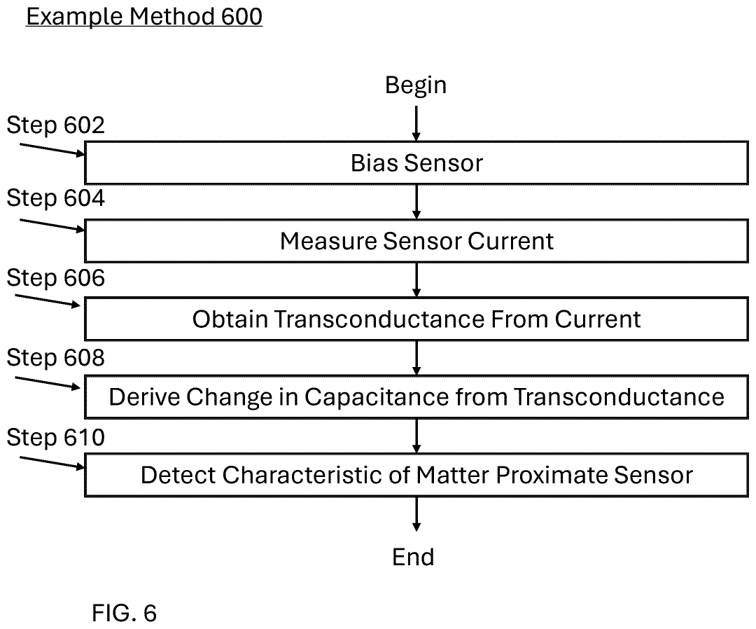

According to various embodiments, bias circuitry 104 and measurement circuitry 106 may be implemented separately such as shown in FIG. 1 or together such as shown in FIG. 6. According to various embodiments, processing circuitry 108 and/or a controller may be implemented together such as shown in FIG. 1 or separately.

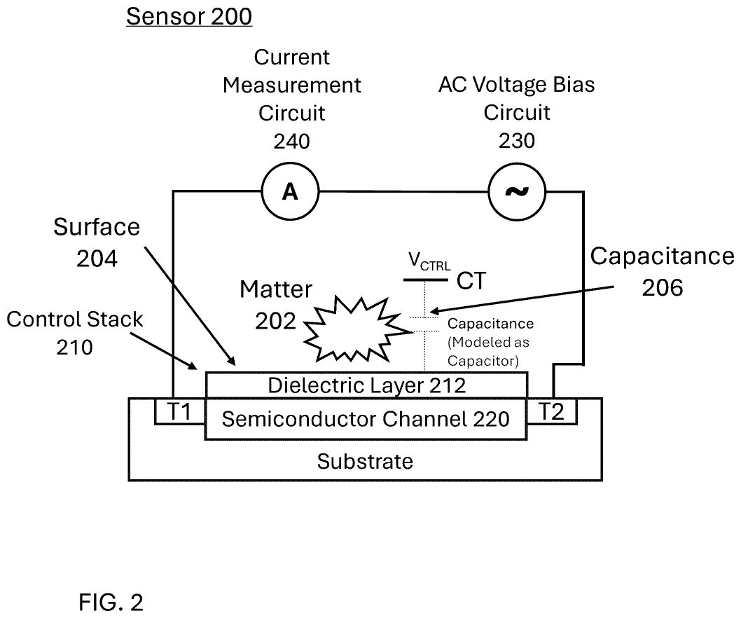

FIG. 2 is a schematic view of an example sensor 200 in a configuration for measuring a capacitance of the sensor 200 indicative of matter 202 at a surface 204 of the sensor 200, according to some embodiments. In the illustrated embodiment, the sensor 200 may be configured as described herein for the sensor 110 shown in FIG. 1.

In some embodiments, current flowing in a semiconductor channel of a sensor and/or between channel terminals of a sensor may indicate a capacitance of the sensor indicative of matter present at a surface of the sensor. For example, in FIG. 2, matter 202 is shown proximate a surface 204 of a control stack 210 of the sensor 200 with the control stack 210 further including a dielectric layer 212 between the surface 204 and the semiconductor channel 220 (e.g., in such embodiments, the surface 204 at which the presence of matter 202 is detected is an outer surface of the dielectric layer 212). For instance, the matter 202 may be present within a medium (not shown) such as a fluid. In the illustrated embodiment, matter 202 may be present proximate the control stack 210 (including the illustrated dielectric layer 212), such as in configuration where buildup of matter 202 on the surface 204 of the control stack 210 may be detected as an indication of the presence of matter 202. According to various embodiments, matter to be detected may be within 20 nm and/or between 3-20 nm of the surface. In some embodiments, changes in thickness of matter 202 may be detected with resolution on the order of picometers. While one dielectric layer 212 is shown schematically in FIG. 2, it should be appreciated that multiple layers of different dielectrics may be used to form one or more dielectric layers in a control stack of a sensor as described herein.

The inventors have recognized that matter present at a surface of the control stack may impact capacitance of the sensor, such as capacitance between the control terminal and the semiconductor channel. For example, the capacitance may reflect an effective dielectric constant of the control stack, such as of material at the surface and/or between the control terminal and the semiconductor channel. For instance, prior to buildup of the matter to be detected at the surface, the dielectric constant may reflect the dielectric constant of the dielectric layer alone and/or with other matter present (e.g., a medium containing the matter to be detected), which may present a first capacitance value. In contrast, once the matter to be detected has built up at the surface, the dielectric constant of the control stack (e.g., at the surface and/or between the control terminal and the semiconductor channel) may be different due to the different mass of dielectric material present at the surface, which may present a second, different capacitance value. A change between the first and second capacitance values may be leveraged, in some embodiments, to detect the matter at the surface. According to various embodiments, capacitance of the sensor may be monitored over time to determine a change in capacitance over time, and/or a capacitance of the sensor may be compared to a baseline capacitance, such as when no matter to be detected is present at the surface (e.g., with or without other matter, such as the medium, being present).

In some embodiments, a capacitance of the sensor may be determined using measured current flowing through a semiconductor channel of the sensor, such as using a transconductance (e.g., relating current flowing the channel to control terminal voltage) obtained using the measured current (e.g., where the voltage at the control terminal is known). For example, in a FET, transconductance gₘ may be given as the change in drain-source current (I_{DS}) with respect to gate-source voltage (V_{GS}) by the following equation:

$${g}_{m} = \frac{\partial {I}_{DS}}{\partial {V}_{GS}} = μ {C}_{o} \frac{W}{L} ( {V}_{GS} - {V}_{T} ) \qquad ( 1 )$$

where μ is charge carrier effective mobility, Cₒ is capacitance between the gate terminal and the semiconductor channel, W is the channel width, L is the channel length, and V_{T} is the threshold voltage at which the gate-source voltage is sufficient to cause the channel to become conductive to current flow. The inventors have recognized that capacitance may be obtained, for example, from transconductance as an indication of effective dielectric constant at the surface, such as reflecting thickness of dielectric material due to matter buildup at the surface.

It should be appreciated that other sensors may have similar relationships with capacitance at a control stack surface, which may be leveraged in other embodiments.

In some embodiments, a thickness of material buildup on a control stack surface may be determined using a determined capacitance obtained using transconductance. For example, in a FET-based sensor, capacitance C may be given by the following equation:

$$C = K {ε}_{0} \frac{A}{d} \qquad ( 2 )$$

where K is a material-dependent constant, ϵ₀ is permittivity of free space, A is the surface area of the control stack surface, and d is the distance corresponding to thickness of the material. For instance, this equation may be manipulated to obtain a value for d given known values for K (e.g., where the material is known from an assay) and A and further using a value for C determined using transconductance.

In some embodiments, matter that builds up proximate a control stack surface may form a layer (e.g., surface layer) having any one of a variety of suitable thicknesses. The thickness of the surface layer may be determined, in some embodiments, using the techniques described herein (e.g., derived from the above capacitance equation). In some embodiments, a surface layer has a thickness of greater than or equal to 25 pm, greater than or equal to 50 pm, greater than or equal to 75 pm, greater than or equal to 100 pm, greater than or equal to 250 pm, greater than or equal to 500 pm, or greater than or equal to 1 nm. In some embodiments, a surface layer has a thickness of less than or equal to 1 nm, less than or equal to 500 pm, less than or equal to 250 pm, less than or equal to 100 pm, less than or equal to 75 pm, less than or equal to 50 pm, or less than or equal to 25 pm. Combinations of the above-referenced ranges are also possible (e.g., greater than or equal to 25 pm and less than or equal to 500 pm, greater than or equal to 25 pm and less than or equal to 250 pm, or greater than or equal to 50 pm and less than or equal to 100 pm). Other ranges are also possible.

In some embodiments, during operation of the sensor 200, when a control voltage V_{CTRL} is applied to the control terminal CT of the sensor 200, the semiconductor channel 220 may become conductive and responsive to a voltage bias (shown in FIG. 2 as an AC voltage bias 230) to cause current to flow in the semiconductor channel 220 between the pair of channel terminals T1, T2, which the illustrated current measurement circuit 240 may be configured to measure. For example, an AC voltage bias across the semiconductor channel 220 may have frequency content within a range from 10 Hz to 100 MHz. For instance, an AC voltage signal applied between the pair of channel terminals T1, T2 may have at least some frequency content at 1 KHz (e.g., constantly applied) and at least some frequency content between 20 KHz and 20 MHZ (e.g., mixed in at various times over the 1 KHz content). In some embodiments, processing circuitry (e.g., 108 in FIG. 1) may be configured to obtain a transconductance of the sensor 200 using the measured current (e.g., with a known control terminal voltage bias value). In some embodiments, the transconductance may indicate a change in transconductance (e.g., which the processing circuitry may be configured to determine), such as with respect to a baseline transconductance (e.g., without presence of the matter to be detected) and/or over time. For example, a change in transconductance may, in turn, indicate a change in capacitance (e.g., with respect to a baseline and/or over time). In some embodiments, the processing circuitry may be configured to detect matter present at the surface of the sensor using the capacitance, such as by determining the effective dielectric constant and/or thickness of dielectric material due to buildup of matter at the surface, such as a change thereof with respect to a baseline and/or over time.

In FIG. 2, an AC voltage bias is applied to the channel terminals T1, T2 of the sensor 200, though in other embodiments a DC voltage may be applied, whether alone, or to provide a DC offset for an AC voltage bias that is further applied. Moreover, it should be appreciated that a DC voltage, AC voltage, and/or AC voltage with DC offset may be applied to the control terminal, as embodiments described herein are not so limited.

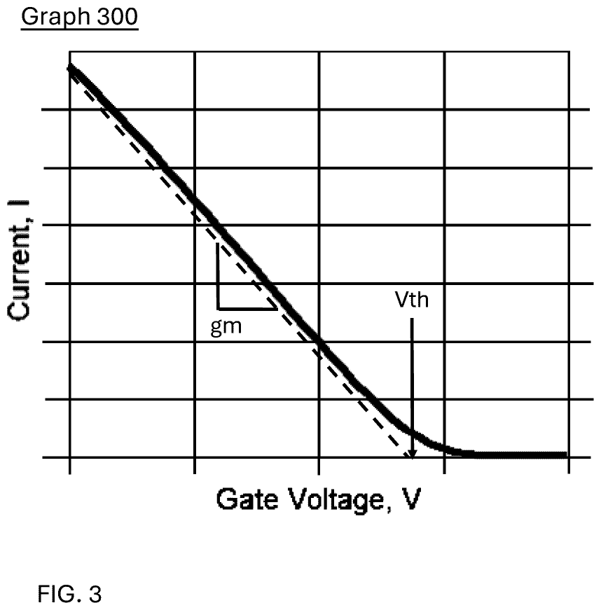

FIG. 3 is a graph 300 of current through a semiconductor channel of a sensor vs. voltage applied to a control terminal of the sensor for a sweep of applied control terminal voltages, according to some embodiments. In the graph 300, the transconductance (gm), which is the slope of the I-V curve, is labeled, as is the threshold voltage (Vth) of the sensor, which is the control terminal voltage at which the sensor channel becomes nonconductive (e.g., the x-intercept of the illustrated curve).

In some embodiments, a controller (e.g., processing circuitry 108 in FIG. 1) of the system may be configured to drive a control terminal CT of a sensor 110 with a sweep of applied control terminal voltages, such that measured current through the sensor may be used to determine transconductance of the sensor as the (e.g., linear) slope of the current-voltage (I-V) curve, such as shown in FIG. 3. In some embodiments, a first sweep of control terminal voltages (e.g., a linear or log-scale sweep) may be applied to determine a first transconductance of the sensor (e.g., prior to any buildup of matter at the surface of the sensor to establish a baseline, and/or at a first point in time). For example, a second transconductance (e.g., obtained from a measured current through the sensor) may be compared to the first transconductance to detect the presence of matter at the surface of the sensor. For instance, the second transconductance may indicate (e.g., via capacitance) matter that was not reflected in the first transconductance, and/or may indicate a presence and/or different amount of matter than reflected in the first transconductance, and/or vice versa.

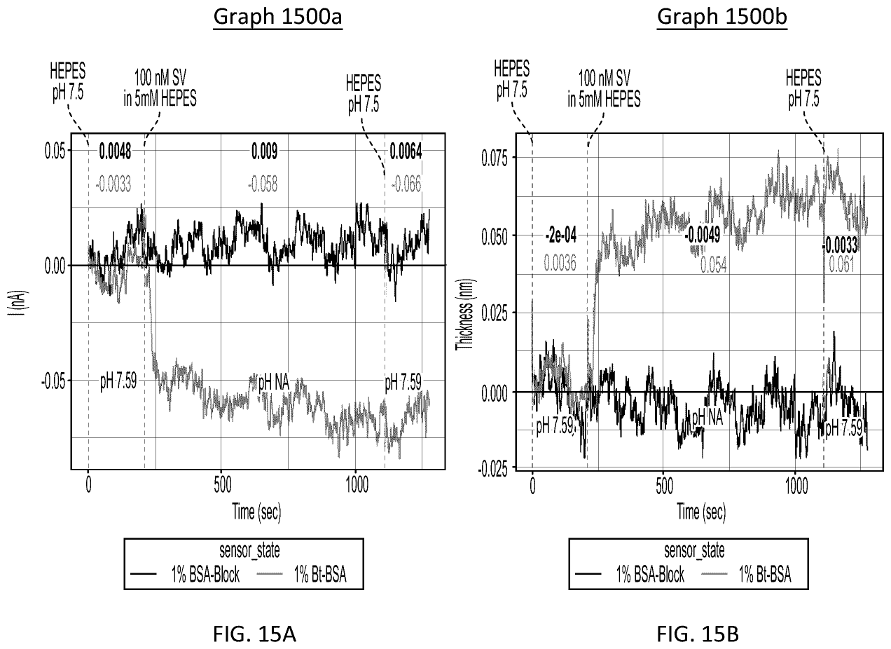

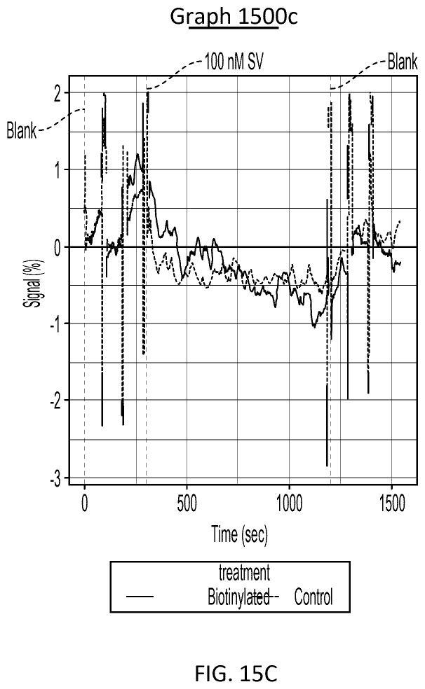

While a sweep of applied control terminal voltages is shown in FIG. 3, it should be appreciated that current may be alternatively or additionally measured using a constant control terminal bias over time, such as described herein in connection with FIGS. 15A-15B.

In some embodiments, a control terminal voltage sweep such as shown in FIG. 3 may be used as at least a portion of a calibration process for a sensor. For example, one or more control terminal voltage sweeps may be used to obtain one or more transconductances using measured currents, which may coincide with separate measurements of concentration of matter at the surface of the sensor. For instance, measurements of concentration of matter may be matched with corresponding transconductances such that (e.g., later) measurements of transconductance with unknown concentrations of matter at the surface may be matched to corresponding concentration values from the calibration process. Some embodiments may leverage capacitance of the sensor, as obtained using transconductance obtained from a measured current through the sensor, to further obtain an amount (e.g., thickness) of matter built up on the sensor. For example, transconductance may be directly proportional to capacitance and/or inversely proportional to matter thickness. For instance, a decrease in transconductance may correlate to an increase in matter (e.g., protein) bound to the sensor surface.

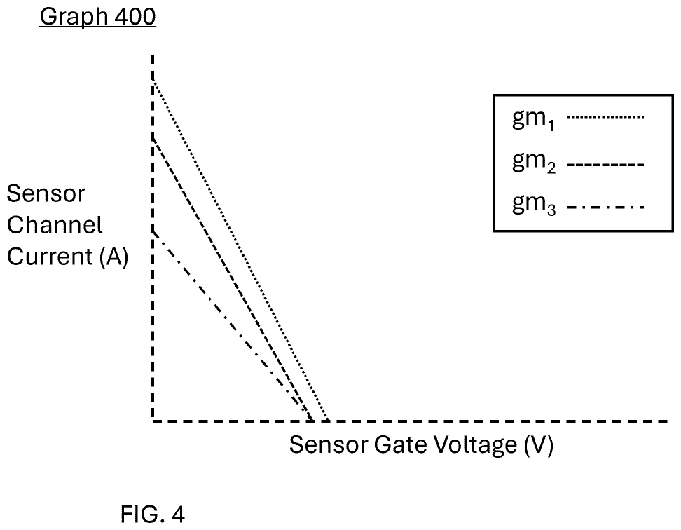

FIG. 4 is a graph 400 of current through a semiconductor channel of a sensor vs. voltage applied to a control terminal of the sensor for a plurality of sweeps of applied control terminal voltages corresponding to a plurality of capacitance states of the sensor, according to some embodiments.

As described above, in some embodiments, matter at the surface of a sensor may be reflected in a capacitance of the sensor, which in turn may be indicated in a transconductance of the sensor, as may be determined from measured current flowing in the sensor. In FIG. 4, a plurality of sweeps of applied control terminal voltages produce the illustrated I-V curves having different slopes, which may indicate different transconductances gm₁, gm₂, and gm₃. The inventors have recognized that, in some embodiments, differences between transconductances of curves such as shown in FIG. 4 may be used to determine differences in capacitance, such as described above (e.g., over time and/or with respect to a baseline). For example, transconductance may be proportional to capacitance (e.g., between the control terminal and channel), which in turn may be proportional to the dielectric constant (ϵᵣ) of material reflected in the capacitance (e.g., between the control terminal and channel), and/or capacitance may be inversely proportional to thickness of material built up on the control stack surface.

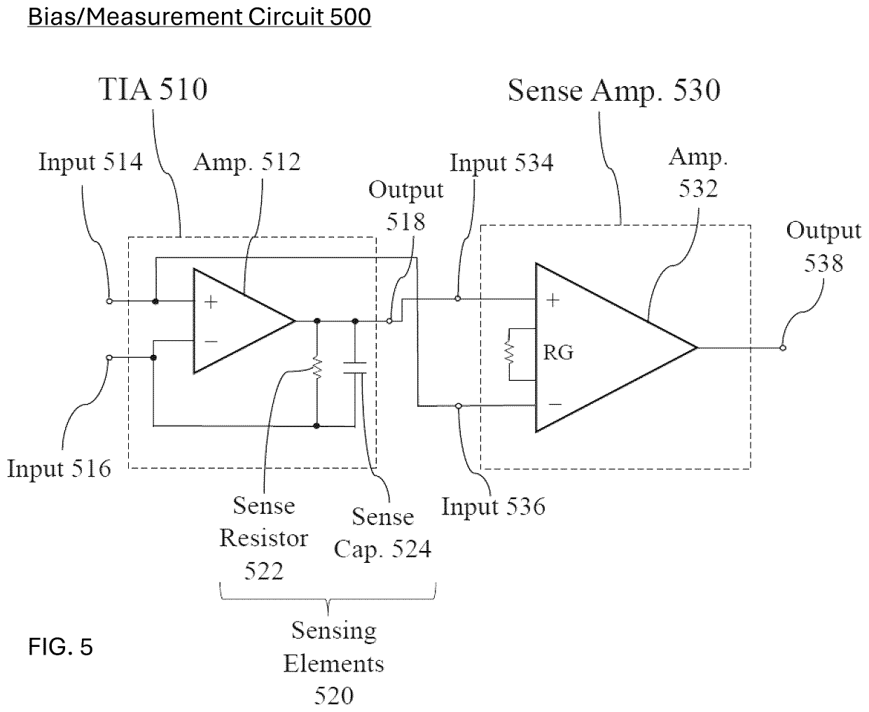

FIG. 5 is a circuit diagram of example sensor biasing and measurement circuitry 500 that may be used in a system described herein, according to some embodiments.

In the illustrated embodiment, a transimpedance amplifier (TIA) 510 and sense amplifier 530 may implement a combined bias circuit and measurement circuit. For example, the TIA 510 may be configured to receive a reference voltage for biasing the sensor (e.g., at a channel terminal) at input 514 of amplifier 512 and the TIA 510 may be configured to provide the reference voltage to the sensor from input 516. For instance, the amplifier 512 may pull the voltage at input 516 to match the same voltage as at input 514. In some embodiments, in response to the reference voltage applied to the sensor, current may flow in the sensor and may further flow through sensing elements 520, shown including sense resistor 522 and sense capacitor 524 (though either or both may be used depending on the application). For example, the current may produce a voltage drop across sensing elements 520 generating a voltage across input 534 of amplifier 532 of sense amplifier 530, which is coupled to sensing elements 520, and input 536 of amplifier 532, which is coupled to input 514 of amplifier 512 to form a high input impedance buffer. In some embodiments, the output 538 of amplifier may be configured to provide a voltage indicative of the measured current, which may be processed (e.g., after digitizing using analog-to-digital conversion circuitry) by processing circuitry 108 (FIG. 1).

FIG. 6 is a flow diagram of an example method of operating a sensor to detect matter at a surface of the sensor using a capacitance of the sensor, according to some embodiments. In FIG. 6, the illustrated method includes biasing the sensor at step 602, measuring current in the sensor at step 604, obtaining a transconductance from the current at step 606, deriving a capacitance from the transconductance at step 608, and detecting a characteristic of matter proximate the sensor at step 610.

In some embodiments, biasing the sensor at step 602 may include applying a voltage to a control terminal (e.g., CT) of the sensor (e.g., 200 in FIG. 2). For example, the control terminal may be in contact with a medium in which matter (e.g., 202 in FIG. 2) is to be detected and/or the control terminal may be configured to bias a control stack (e.g., 210 in FIG. 2) to control a semiconductor channel (e.g., 220 in FIG. 2) of the sensor. In some cases, charge buildup from matter at the surface may further control the semiconductor channel, such as by affecting voltage at the control stack. In some embodiments, an applied control terminal voltage may vary over time, such as in a sweep, and/or a constant control terminal voltage may be applied.

In some embodiments, measuring the sensor current at step 604 may include obtaining a current flowing in the semiconductor channel, such as between a pair of channel terminals (e.g., T1, T2 in FIG. 2) of the sensor. For example, a voltage (e.g., DC and/or AC) may be further applied across the pair of channel terminals to obtain a resulting current. For instance, in the example of FIG. 5, the current may be measured using sensing elements 520.

In some embodiments, a method described herein may further include the illustrated step 606 of obtaining a transconductance from the measured current. For example, the transconductance may be obtained by dividing the measured current by the voltage applied to the control terminal. In some cases, the voltage applied to the control terminal may be measured as well. In some cases, the voltage applied to the control terminal may be known rather than measured or incorporated from the controller, such as where constant control terminal voltage and/or a known range of control terminal voltages are pre-programmed to be applied to the control terminal.

In some embodiments, a method described herein may include deriving a capacitance of the sensor from an obtained transconductance at step 608. For example, where the transconductance has a known relationship to capacitance, a change in transconductance (e.g., with respect to a baseline before buildup of matter at the control stack surface and/or over time) may be indicated in measured current and used to obtain a corresponding change in capacitance. For instance, in a FET-based sensor, a change in transconductance may be proportional to a change in capacitance between the control terminal and the semiconductor channel.

In some embodiments, a method described herein may include detecting a characteristic of matter proximate the sensor at step 610, such as the presence of, and/or a change in an amount of a type of matter proximate the sensor, using a capacitance of the sensor. For example, a capacitance of the sensor may indicate a dielectric constant of the control stack of the sensor and/or thickness of material at the control stack, such as indicating buildup of matter at the control stack surface. For instance, the matter to be detected may be distinguished from other matter (e.g., a surrounding fluid) based on its relatively greater impact on capacitance of the sensor. In a non-limiting example, analytes binding to a surface of a sensor may present a dielectric mass that impacts capacitance of the sensor, whereas fluid containing the analytes may present little to no dielectric mass, thereby having little to no impact on capacitance of the sensor).

### Electrochemical Interface Mitigation Techniques

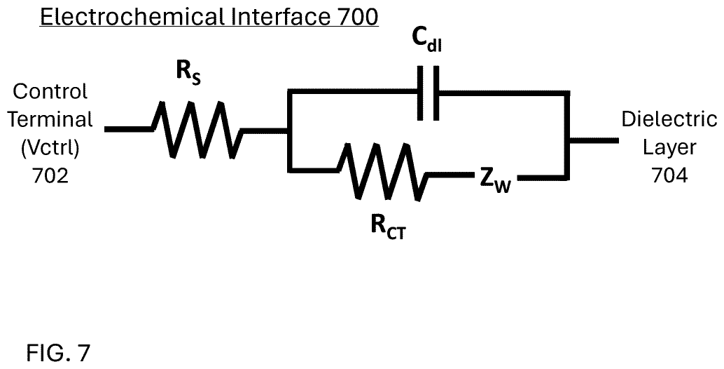

FIG. 7 is a circuit diagram modeling an example electrochemical interface 700 at a surface of a sensor, according to some embodiments.

In some embodiments, the electrochemical interface 700 modeled in FIG. 7 may be between a medium and a surface of a sensor (e.g., 200 in FIG. 2). For example, the medium (e.g., a fluid) may include matter (e.g., a species, such as a chemical and/or biological species) whose presence is to be detected using the sensor, such as described herein including in connection with FIGS. 1-2. Similarly, the surface of the sensor may include a dielectric layer of a control stack (e.g., 210 in FIG. 2), such as an outermost layer on which matter to be detected may build up.

In some embodiments, the electrochemical interface 700 modeled in FIG. 7 may include a capacitance and one or more resistances. For example, in FIG. 7, the electrochemical interface 700 is modeled as a Randles circuit including an electrical double-layer capacitance C_{dl} in parallel with a series configuration of a contact resistance R_{CT} and a Warburg diffusion element z_{w}, and the parallel configuration is further in series with a solution resistance R_{S}. For instance, the electrical double-layer capacitance C_{dl} may model the charging and discharging of ions at the interface between the medium and the surface of the sensor, the contact resistance R_{CT} may model losses due to surface resistance in the charging and discharging process, the Warburg diffusion element z_{w} may model diffusion of ions through the electrical double-layer capacitance C_{dl}, and the solution resistance R_{S} may model losses due to ion transport through the medium. It should be appreciated that other electrochemical interface models (e.g., having higher complexity than the Randles model) may be used within the scope of the present disclosure.

In some embodiments, presence of matter (e.g., 202 in FIG. 2) proximate a surface of a sensor (e.g., 200 in FIG. 2) may be detected based on a resulting change in capacitance within the electrochemical interface. Detection may be qualitative or quantitative. For example, as matter builds up proximate the surface of the sensor, the electrical double-layer capacitance C_{dl} may decrease (e.g., due to the increasing dielectric constant between the double-layers). In this example, the changing double-layer capacitance C_{dl} may impact the apparent control terminal capacitance of the sensor as reflected in AC current flowing through the semiconductor channel of the sensor. The inventors have recognized that this change in capacitance (and/or its indication in a change in transconductance) provides an advantageous manner of detecting the presence of matter with high immunity to noise.

Moreover, as described further herein, the inventors have developed techniques that emphasize changes in capacitance at the electrochemical interface in AC current flowing through the sensor for high accuracy measurements.

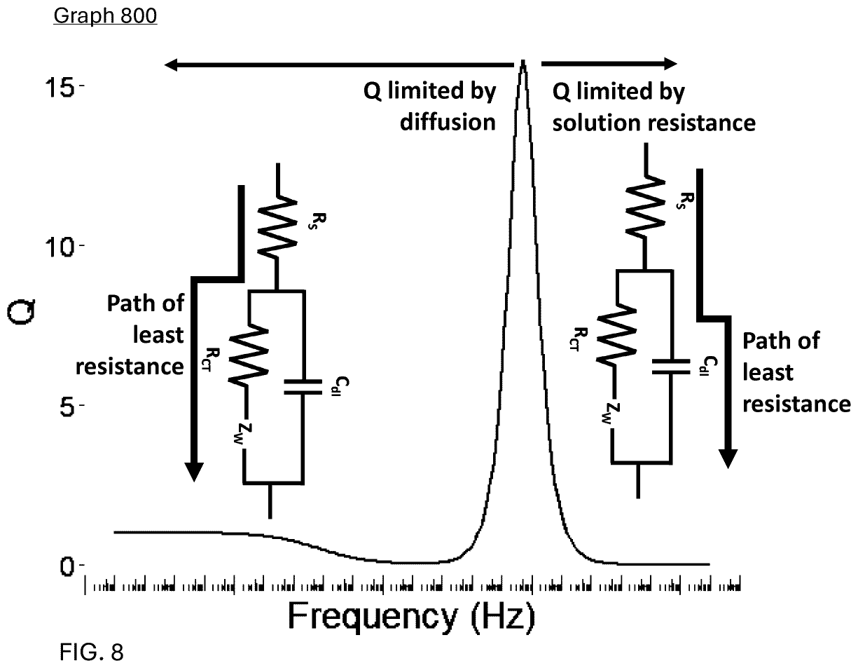

FIG. 8 is an annotated graph of quality factor (Q) over frequency for AC signals used to bias the semiconductor channel of the sensor of FIG. 7, according to some embodiments.

In some embodiments, an electrochemical interface between a medium and a surface of a sensor may have a high-pass cutoff frequency that is based on a diffusion impedance and a double-layer capacitance of the electrochemical interface. For example, in the model of FIG. 7, the electrochemical interface 700 includes a diffusion impedance represented by the Warburg diffusion element z_{w} and an electrical double-layer capacitance C_{dl}, which may produce a high-pass cutoff frequency. For instance, at frequencies below the high-pass cutoff frequency, diffusion may significantly impact the amount of energy charged and discharged from the capacitance during a given signal period, as the impedance of the capacitance is large by comparison (e.g., due to the capacitance becoming fully charged early on in the signal period). In contrast, above the high-pass cutoff frequency, diffusion may have little to no impact on the amount of energy charged and discharged from the capacitance during a given signal period, as the impedance of the capacitance is small by comparison (e.g., due to the capacitance not becoming fully charged until late, if at all, within the signal period). In the graph 800 of FIG. 8, the high-pass cutoff frequency is represented by a sharp rise in Q over frequency. It should be appreciated that the high-pass cutoff frequency may be further based on the contact resistance R_{CT} in that the contact resistance R_{CT} may add to the impedance presented by the diffusion element, thereby further limiting energy charged and discharged by the double-layer capacitance. In some embodiments, the frequency response of the electrochemical interface may be divided between a first frequency region, in which Q is limited by diffusion, a second frequency region, in which Q is limited by solution resistance, and a third frequency region that is between the first and second frequency regions. For example, as shown in FIG. 8, the first frequency region corresponds to frequencies below the high-pass cutoff frequency based on diffusion impedance and electrical double-layer capacitance. Similarly, as shown in FIG. 8, the second frequency region corresponds to the peak in Q that occurs in frequencies above the high-pass cutoff frequency. Moreover, as shown in FIG. 8, the third frequency region corresponds to frequencies above the second frequency region. For example, in the third frequency region, the electrical double-layer capacitance may not be significantly charged or discharged within the signal period by the amount of current that passes through the solution resistance, resulting in a decline in Q as frequency increases.

The inventors have recognized that biasing a sensor (e.g., 200 in FIG. 2) with an AC signal having frequency content within the second frequency region may emphasize changes in capacitance at the electrochemical interface in AC current flowing through the sensor, such as described herein. The inventors have further recognized that including frequency content in a different frequency region in the AC signal may provide additional benefits, such as reducing leakage of the AC current through the control terminal of the sensor, as described herein.

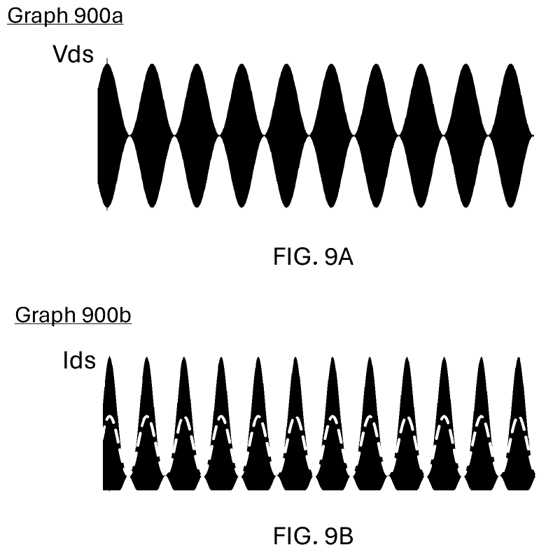

FIG. 9A is a graph 900a of voltage over time for an example AC signal that may be used to bias the semiconductor channel of the sensor of FIG. 7, according to some embodiments.

In some embodiments, the semiconductor channel of the sensor may be biased using an AC signal having a carrier frequency and a modulation frequency. For example, as shown in FIG. 9A, the AC signal has modulation frequency content indicated by the envelope at the upper and lower amplitude bounds of the signal and carrier frequency content indicated within the envelope around the AC signal. In some embodiments, an amplitude modulated AC signal may be generated by mixing a modulation signal having a modulation frequency with a carrier signal having a carrier frequency. For example, the modulation may include one or two full sidebands, one or two suppressed sidebands, and/or a suppressed carrier depending on the implementation. In the illustrated example, the modulation frequency and the carrier frequency may result from amplitude modulation, though other forms of modulation are contemplated within the scope of the present aspects.

In some embodiments, an AC signal may have a carrier frequency based on an electrochemical interface between a medium and a surface of the sensor. For example, the carrier frequency may be above a high-pass cutoff frequency that is based on a diffusion impedance and a double-layer capacitance of the electrochemical interface between the medium and the surface of the sensor. For instance, as described above, below the high-pass cutoff frequency, diffusion may significantly impact charging and discharging of the double-layer capacitance. The inventors have recognized that this impact may conceal changes in the double-layer capacitance from being indicated in the electrical response of the sensor to applied AC signals.

In some embodiments, the AC signal may have a carrier frequency between 20 KHz and 20 MHz, such as in a range from 100 KHz to 300 KHz, 150 KHz to 250 KHz, and/or 200 KHz. In some embodiments, the AC signal may have an amplitude between 50 mV and 150 mV, such as 100 mV.

In some embodiments, the modulation frequency may be based on an electrical characteristic of the semiconductor channel. For example, the modulation frequency may be below a threshold frequency of the semiconductor channel that is based on gate-to-channel leakage of the semiconductor channel. The inventors have recognized that, at high frequencies (e.g., in the second frequency region shown in FIG. 8), a significant amount of AC current may leak from the semiconductor channel through undesired paths (e.g., via the control terminal). To mitigate the impact of such electrical characteristics of the semiconductor channel, an applied AC signal may further have a modulation frequency that mitigates the impact of higher frequency content in the carrier frequency on strength of the AC current.

In some embodiments, the AC signal may have a modulation frequency between 500 Hz and 2 KHz, such as between 750 Hz and 1.25 KHz, and/or 1 KHz.

FIG. 9B is a graph 900b of current over time for the example AC signal of FIG. 9A, according to some embodiments.

In some embodiments, AC current may be measured flowing through the semiconductor channel of the sensor in response to biasing the semiconductor channel with the AC signal. For example, the AC current shown in FIG. 9B may flow in the semiconductor channel in response to the semiconductor channel being biased with the AC signal shown in FIG. 9A. In the illustrated example, the envelope of the AC current has the modulation frequency of the AC signal shown in FIG. 9A, which is further superimposed over the AC current in FIG. 9B. Also in the illustrated example, the content within the envelope of the AC current has the carrier frequency of the AC signal shown in FIG. 9A. While the illustrated example shows at least some rectification of the AC signal of FIG. 9A in the AC current of FIG. 9B, it should be appreciated that some sensors may not produce such a response.

In some embodiments, the AC voltage shown in FIG. 9A may be subtracted from a known gate voltage applied to the control terminal of the sensor to obtain the control terminal to channel terminal voltage difference (e.g., gate-source voltage). For example, relating the control terminal to channel terminal voltage to the AC current shown in FIG. 9B may produce a transconductance point for determining a change in transconductance of the sensor (e.g., indicative of buildup of matter proximate the surface of the sensor).

In some embodiments, a presence and/or amount of matter in the medium disposed proximate the surface of the sensor may be determined using the AC current.

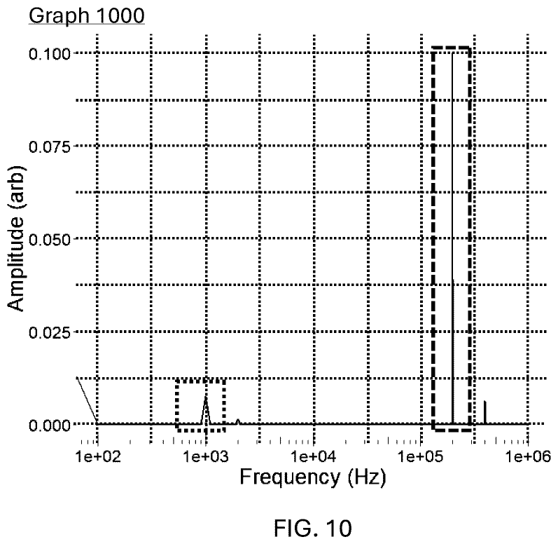

FIG. 10 is a graph 1000 of AC signal amplitude over frequency for the example AC signal of FIG. 9A, according to some embodiments.

As shown in FIG. 10, the AC signal includes frequency content at a carrier frequency and at a modulation frequency. For example, most of the power spectral density in the AC signal may be at or around (e.g., in sidebands of) the carrier frequency. In the illustrated example, the carrier frequency is shown as 200 KHz and the modulation frequency is shown as 1 KHz, though other frequencies may be used depending on the implementation.

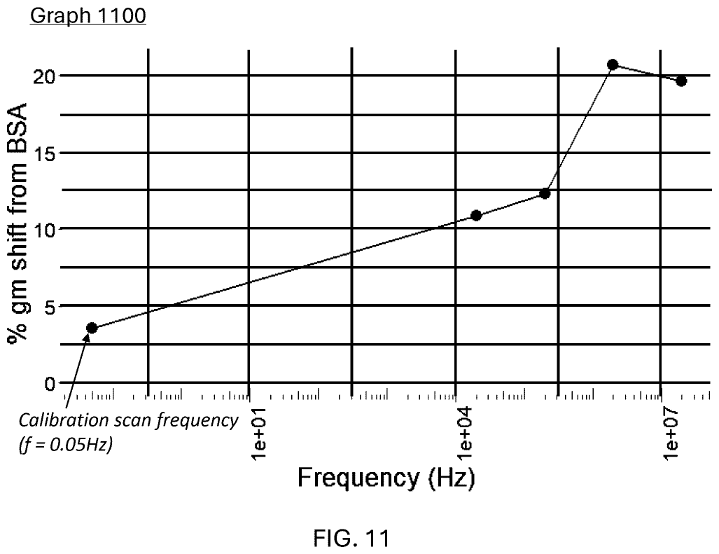

FIG. 11 is a graph 1100 of measured percentage change in transconductance over frequency for an example sensor, according to some embodiments.

The graph 1100 in FIG. 11 corresponds to an experiment in which the carrier frequency of an AC signal was swept from 0.05 Hz to 20 MHz before and after 1% bovine serum albumin (BSA)-block as a BSA blocking buffer was applied to a surface of the control stack of the sensor. The graph 1100 shows that the change in transconductance between before and after application of BSA-block was lowest at the lowest frequency of 0.05 Hz, higher as frequency increased up to a peak at about 2 MHz, and then lower in frequencies above the peak. The graph 1100 of FIG. 11 is consistent with the graph 800 of Q in FIG. 8 indicating that changes in transconductance due to material buildup on a surface of a sensor may be most detectable in a second frequency region between a first frequency region (e.g., in which diffusion may limit detectability) and a third frequency region (e.g., in which solution resistance may limit detectability).

In some embodiments, sensing techniques described herein may include determining a change in transconductance of a sensor indicative of matter at a surface of a sensor, which may include determining a percent change in the transconductance of the sensor. Examples of percent changes in transconductance of a sensor that may indicate matter at the surface of the sensor, in some implementations, include at least 10%, at least 15%, and at least 20% changes in transconductances. For instance, in FIG. 11, the peak change in transconductance was above 20% at around 2 MHz.

Alternatively or additionally, sensing techniques described herein may include determining a change in capacitance of a sensor indicative of matter at a surface of a sensor, which may include determining a percent change in the capacitance of the sensor. For example, in FIG. 11, a change in capacitance may be derived from a change in transconductance using techniques described further herein.

### Example Applications

The inventors have recognized that sensing techniques described herein may be useful for determining a presence of a species in matter at the surface of a sensor. For example, a change in capacitance and/or change in transconductance of the sensor may indicate a presence and/or amount of the species in the matter at the surface of the sensor. For instance, in some techniques described herein, an AC bias may be applied across the semiconductor channel of the sensor while the matter is building up at the surface of the sensor, such that AC current measured flowing through the semiconductor channel indicates the presence of the species (e.g., due to a resulting decrease in capacitance at the control stack of the sensor).

Some aspects of the present disclosure relate to application of sensing techniques described herein to direct-detection of a species bound to a surface of the sensor. In some embodiments, determining the presence of a species in matter at the surface of the sensor may include determining whether the species is bound to the surface of the sensor. For example, the surface of the sensor may include (e.g., be treated with) a molecule that selectively binds to the species. In this or another example, a fluid including the species may be deposited on the surface of the sensor. For instance, the fluid may include bodily fluid, such as blood, plasma, saliva, tears, urine, nasal fluid, and/or nasopharyngeal fluid. In some embodiments, depositing the fluid on the surface of the sensor may cause the species to bind to the surface of the sensor. For example, an amount of the species that binds to the surface may be based on an amount and/or concentration of the species in the fluid. For instance, the binding may occur due to a known reaction or interaction between the species in the fluid and a molecule treated on the surface of the sensor.

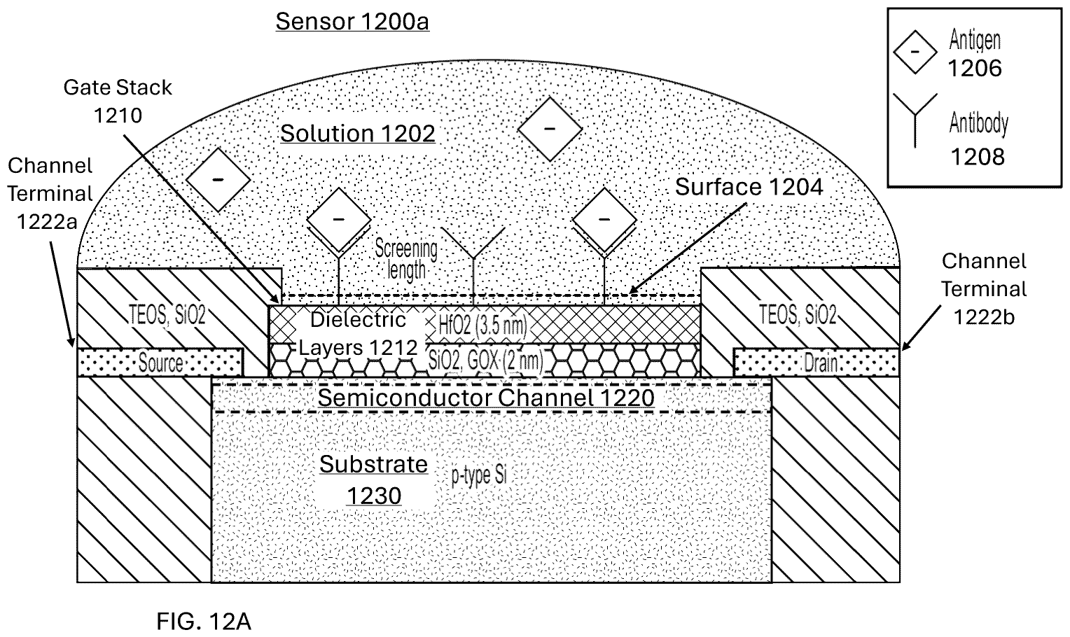

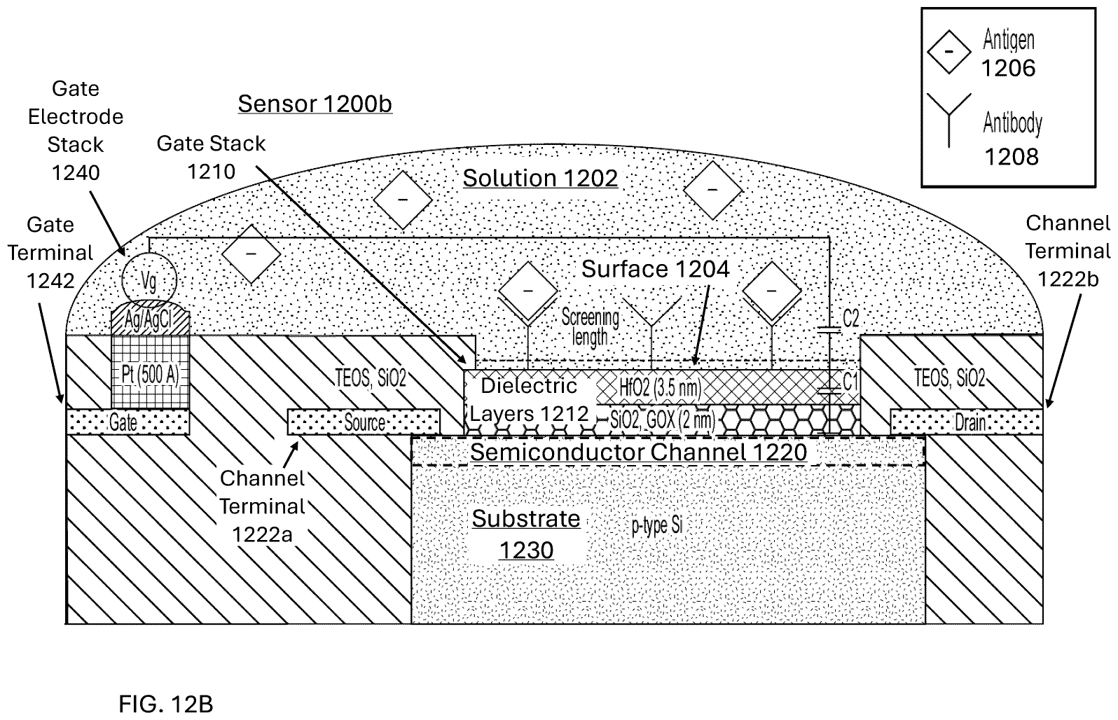

According to various embodiments, a species detected using techniques described herein may be an organic species, such as a protein and/or a biomarker. As one example, a detected biomarker may be a biomarker for brain injury, such as GFAP, S100B, UCH-L1, and/or NFL-1. FIG. 12A is a cross-section of an example sensor 1200a with solution 1202 proximate a surface 1204 of the sensor 1200a, the surface 1204 being treated to bind antigens 1206 in the solution 1202 to the surface 1204, according to some embodiments. FIG. 12B is a cross-section of another example sensor 1200b in a similar configuration to the sensor 1200a of FIG. 12A, further illustrating a gate terminal 1242 on a common substrate 1230 with the channel and other terminals, according to some embodiments.

In some embodiments, a sensor as described herein may be configured to detect the presence of analytes proximate a surface of the sensor (e.g., the matter detected and/or configured to be detected may be an analyte), such as for biosensing applications. For example, in FIG. 12A, a FET-based sensor 1200a has a fluid, in this case a solution 1202, proximate the gate stack surface 1204 of the sensor 1200a. In the illustrated embodiment, antigens 1206 with negative charge may be selectively bound to antibodies 1208 treated on the surface 1204, thereby presenting the antigens 1206 as matter at the surface 1204 of the sensor 1200a, which may be detected (e.g., distinguished from the solution 1202 and/or from before binding to the surface 1204) using some techniques described herein. For instance, when antigens 1206 bind to the surface 1204, the capacitance at the surface 1204 may change, as may be indicated in current flowing in the semiconductor channel 1220 (e.g., at the top of the illustrated substrate 1230) between the channel terminals 1222a-1222b, such as by observing differences in transconductance obtained from current measurements (e.g., before and after the antigens 1206 bind to the surface 1204). In the illustrated embodiment of FIG. 12B, the presence of antigens 1206 bound to the control stack surface 1204 may be modeled, at least at some AC frequencies, as a capacitance C2 in series with the gate stack capacitance C1. For instance, transconductance (and proportionally, capacitance of the sensor 1200b) may decrease (e.g., over time and/or with respect to a baseline) as antigens 1206 build up on the gate stack surface 1204. In some cases, at DC, the series capacitance C2 may exhibit behavior that more closely resembles a large resistor than a capacitor.

In the illustrated embodiments of FIGS. 12A-12B, the FET-based sensors 1200a-1200b have a silicon (Si) substrate 1230, source and drain terminals 1222a-1222b with tetraethyl orthosilicate (TEOS) and silicon dioxide (SiO₂) electrodes, and a gate stack 1210 including a first dielectric layer of silicon dioxide as a gate oxide (GOX) layer and a hafnium oxide (HfO₂) layer 1212. In FIG. 12B, the gate terminal 1242 is on the Si substrate 1230 and has an electrode stack 1240 including platinum and silver (Ag)/silver chloride (Ag/Cl), though other materials may be used (e.g., gold), and the gate terminal 1242 may be located elsewhere in other embodiments while being configured to contact the solution 1202 (e.g., to thereby be in electrical communication with the semiconductor channel 1220). The gate terminal 1242 of the sensor 1200b is not shown in FIG. 12A, but may be configured to contact the solution 1202 shown in FIG. 12A in some embodiments. In other embodiments, materials used to form a semiconductor-based sensor may vary. For example, suitable materials that produce a high maximum transconductance (e.g., prior to buildup of material at the control stack surface) may be advantageous, at least in some cases, by having high tolerance for noise.

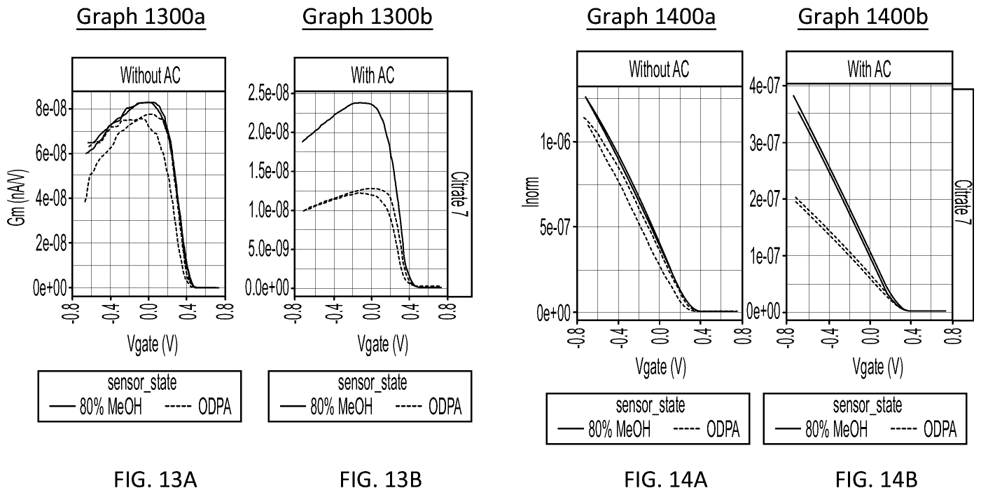

FIG. 13A is a graph 1300a of transconductance (Gm) vs. gate voltage for a FET-based sensor obtained from current measured from the sensor in response to a DC voltage bias applied to the sensor, according to some embodiments. FIG. 13B is a graph 1300b of transconductance vs. gate voltage for the FET-based sensor of FIG. 13A obtained from current measured from the sensor in response to an AC voltage bias applied to the sensor, according to some embodiments.

For the graph 1300a of FIG. 13A, a solvent of 80% methanol (MeOH) was deposited on the control stack surface of a FET-based sensor, and a sweep of control terminal voltages was applied to the control terminal of the sensor. In addition, an organic monolayer of octadecylphosphonic acid (ODPA) was deposited on the control stack surface of a FET-based sensor, and the same sweep of control terminal voltages was applied to the control terminal of the sensor. In each case, a DC voltage was applied across the channel terminals of the sensor and a current between the channel terminals of the sensors was measured. The transconductance values shown in the graph 1300a of FIG. 13A were obtained by dividing the measured currents by the applied control terminal voltages. The OPDA deposition resulted in a lower transconductance of the device as compared to the methanol deposition.

For the graph 1300b of FIG. 13B, the same experiment was conducted except that an AC voltage with a DC offset was applied across the channel terminals of the sensor, resulting the measured current including an AC current. From comparison of FIGS. 13A-13B, the difference in transconductance was emphasized when an AC voltage was applied, which may make for more sensitive detection in some embodiments.

In some embodiments, a thickness of material buildup on the sensor control stack surface in the example of FIGS. 13A-13B may be obtained based on determined capacitance of the sensor (e.g., compared to a baseline). For example, the MeOH solvent may be considered a baseline for an untreated control stack surface and the ODPA may be considered as matter to be detected. For instance, the relationship between transconductance and capacitance for the two cases may be given by:

$$\frac{{g}_{mTotal}}{{g}_{muntreated}} = \frac{{C}_{Total}}{{C}_{untreated}} \qquad ( 3 )$$

Where g_{mTotal} is the transconductance including OPDA, g_{muntreated} is the baseline, C_{Total} is the capacitance further including OPDA, and C_{untreated} is the capacitance of the baseline without ODPA. In the case where capacitance added by ODPA (C_{ODPA}) is modeled as a series capacitance, the capacitance further including OPDA by be given by:

$$\frac{1}{{C}_{Total}} = \frac{1}{{C}_{untreated}} + \frac{1}{{C}_{ODPA}} \qquad ( 4 )$$

Using the capacitance equation described above in connection with FIG. 2 in the example FET-based sensor configurations 1200a-1200b shown in FIGS. 12A-12B and the example depositions of FIGS. 13A-13B, the baseline capacitance may be given by:

$${C}_{untreated} = \frac{{ε}_{0} A * {K}_{HfO 2} {K}_{SiO 2}}{{K}_{SiO 2} {d}_{HfO 2} + {K}_{HfO 2} {d}_{SiO 2}} \qquad ( 5 )$$

where K_{HfO2} and K_{SiO2} are material-dependent constants for the dielectric layers in the example configurations of FIGS. 12A-12B, and d_{HfO2} and d_{SiO2} are thicknesses of the respective dielectric layers. Modeling as a series capacitance per the series capacitance equation above, the capacitance contribution from the ODPA buildup may be given by:

$${C}_{ODPA} = \frac{{C}_{Total} * {C}_{untreated}}{{C}_{untreated} - {C}_{Total}} = K {ε}_{0} \frac{A}{{d}_{ODPA}} \qquad ( 6 )$$

from which the thickness of the ODPA buildup may be isolated as d_{ODPA} using the following equation:

$${d}_{ODPA} = \frac{{K}_{ODPA} {ε}_{0} A ( {g}_{muntreated} - {g}_{m T o t a l} )}{{g}_{mTotal} {C}_{untreated}} \qquad ( 7 )$$

where K_{ODPA} is a material-dependent constant for the ODPA buildup.

While this example is illustrative of one process for obtaining a thickness of material buildup on a control stack surface, other processes may be used whether in the example provided or for a particular use case and/or sensor configuration.

FIG. 14A is a graph 1400a of normalized current measured from the sensor of FIG. 13A in response to the DC voltage bias, according to some embodiments. FIG. 14B is a graph 1400b of normalized current measured from the sensor of FIG. 13B in response to the AC voltage bias, according to some embodiments.

The graphs 1400a-1400b of FIGS. 14A-14B show slopes of normalized measured current versus applied control terminal voltages for the experiments described in connection with FIGS. 13A-13B, from which the transconductance values shown in the graphs of FIGS. 13A-13B may be obtained, respectively. From comparing FIGS. 14A-14B, the difference in slope was emphasized when an AC voltage was applied across the channel terminals.

FIG. 15A is a graph 1500a of current vs. time for current measured from a FET-based sensor in multiple states of the sensor, according to some embodiments. FIG. 15B is a graph 1500b of material thickness vs. time for current measured from the FET-based sensor of FIG. 15A in the multiple states of the sensor, according to some embodiments.

The graphs 1500a-1500b of FIGS. 15A-15B show current (FIG. 15A) and material thickness (FIG. 15B) over time for two experiments. In the first experiment, prior to the illustrated time period, the control stack surface was initially exposed to 1% bovine serum albumin (BSA)-block as a BSA blocking buffer, which coated the control stack surface. In the second experiment, prior to the illustrated time period, the control stack surface was initially exposed to 1% biotinylated BSA (Bt-BSA), which coated the control stack surface. During the illustrated time period (starting at the first dashed vertical line), in each experiment, the control stack surface was exposed a composition of 7.5 pH zwitterionic sulfonic acid buffering agent (4-(2-hydroxyethyl)-1-piperazineethanesulfonic acid) (HEPES), with a constant DC control terminal voltage applied and an AC channel terminal voltage applied, and current between the channel terminals was measured over time. At a point in time shortly before 250 seconds (at the second dashed vertical line), in each experiment, the control stack was exposed to a composition of 5 mM HEPES and 100 mM streptavidin (SV), with a constant DC control terminal voltage applied and an AC channel terminal voltage applied, and current between the channel terminals continued to be measured over time. At a point in time shortly before 1125 seconds (at the third dashed vertical line), in each experiment, the control stack surface was exposed to another injection of 7.5 pH HEPES.

FIG. 15A illustrates measured current over time during the experiments, and FIG. 15B illustrates change in material thickness obtained using the measured currents of FIG. 15A. Prior to the control stack surface being exposed to streptavidin (before the second dashed vertical line), no binding at the control stack surface was expected, which translated to a substantially constant AC current sensor output being measured, as shown in FIG. 15A. Given the known binding interaction between biotin and streptavidin, once the control stack surface was exposed to streptavidin in the second experiment (after the second dashed vertical line), the measured current response from the sensor declined. The decline in current may be attributed to a decrease in transconductance resulting from a decrease in capacitance resulting from buildup at the control stack surface from the interaction. The change in thickness of matter at the control stack surface was obtained using the transconductance and its relationship to capacitance to produce the thickness curve shown in FIG. 15B, which is shown to increase as the measured current decreases in FIG. 15A. And, no significant change to measured current or obtained thickness is shown following injection of the additional HEPES (at the third dashed vertical line), indicating that the buildup on the control stack surface reflected binding to the surface. In contrast, in the first experiment, no interaction was expected between the BSA block and the streptavidin, and no significant change in measured current is shown in FIG. 15A, and no significant change in thickness is shown in FIG. 15B.

In addition to the above examples, in some embodiments, techniques described herein may be alternatively or additionally used for detecting any organic and/or non-organic material accumulating on a control stack surface, for detecting and/or quantifying DNA, peptides, proteins, small molecules, polymers, bacteria, and/or any other organic or non organic material of interest.

FIG. 15C illustrates measured change in gate threshold voltage of a FET-based sensor during two experiments similar to the experiments of FIGS. 15A-15B, according to some embodiments.

As in the experiments of FIGS. 15A-15B, prior to the illustrated time period, the control stack surface was initially exposed to 1% bovine serum albumin (BSA)-block as a BSA blocking buffer, which coated the control stack surface. In the second experiment, prior to the illustrated time period, the control stack surface was initially exposed to 1% biotinylated BSA (Bt-BSA), which coated the control stack surface. During the illustrated time period (starting at the first dashed vertical line), in each experiment, the control stack surface was exposed to a composition of 7.5 pH zwitterionic sulfonic acid buffering agent (4-(2-hydroxyethyl)-1-piperazinecthanesulfonic acid) (HEPES), with a constant DC control terminal voltage applied and an AC channel terminal voltage applied, and current between the channel terminals was measured over time. At a point in time shortly after 250 seconds (at the second dashed vertical line), in each experiment, the control stack was exposed to a composition of 5 mM HEPES and 100 mM streptavidin (SV), with a constant DC control terminal voltage applied and an AC channel terminal voltage applied, and current between the channel terminals continued to be measured over time. At a point in time shortly before 1250 seconds (at the third dashed vertical line), in each experiment, the control stack surface was exposed to another injection of 7.5 pH HEPES.

As shown in FIG. 15C, there are some observable differences in how the gate threshold voltage of the sensor changed in each experiment, but the differences are significantly less observable for these experiments using the gate threshold voltage detection method than using a change in transconductance and/or capacitance, as indicated in the graphs 1500a-1500b of FIGS. 15A-15B.

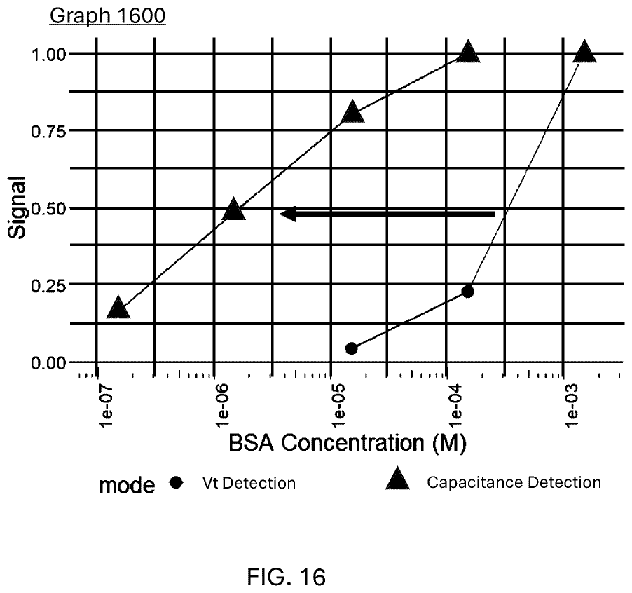

FIG. 16 illustrates normalized change in signal over a range of concentrations of Bt-BSA applied to a surface of a FET-based sensor, according to some embodiments.

The graph 1600 of FIG. 16 corresponds to a set of experiments in which increasing concentrations of Bt-BSA were applied to a FET-based sensor in a manner similar to the experiments of FIGS. 15A-15B. In one group of the experiments, the presence of Bt-BSA was detected using a change in gate threshold voltage whereas in another group of experiments, the presence of Bt-BSA was detected using a change in capacitance indicated by a change in transconductance.

As shown in FIG. 16, the range of Bt-BSA concentrations that were detected using a change in gate threshold voltage ran from about 10 μM to about 1 mM. In contrast, the range of Bt-BSA concentrations that were detected using a change in capacitance ran from about 100 nM to about 100 μM. In these experiments, detection using a change in capacitance was effective over a larger range of Bt-BSA concentrations than using change in gate threshold voltage, and was able to detect a significantly smaller Bt-BSA concentration than when using a change in gate threshold voltage.

### Example Processing Circuitry

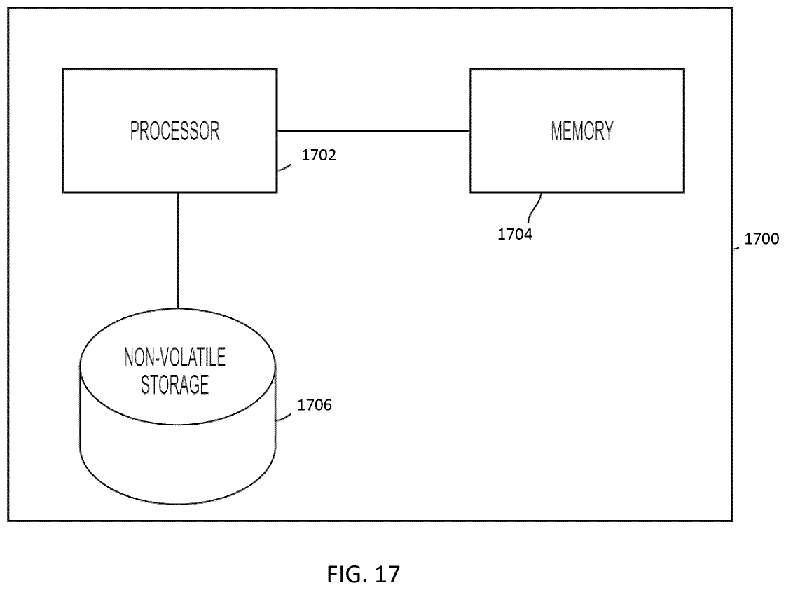

FIG. 17 is a block diagram of example processing circuitry 1700 that may be configured to perform at least some processing operations described herein for the system described above, in accordance with some embodiments.

In some embodiments, determinations (e.g., of transconductance, capacitance, dielectric constant, and/or thickness) described herein may be performed using processing circuitry 1700 (e.g., implemented using components mounted on and/or coupled to a substrate of a device). Processing circuitry 1700 may include one or more processors 1702 and one or more articles of manufacture that comprise non-transitory computer-readable storage media (e.g., memory 1704 and one or more non-volatile storage media 1706). The processor 1702 may control writing data to and reading data from the memory 1704 and the non-volatile storage device 1706 in any suitable manner, as the aspects of the disclosure provided herein are not limited in this respect. To perform any of the functionality described herein, the processor 1702 may execute one or more processor-executable instructions stored in one or more non-transitory computer-readable storage media (e.g., the memory 1704), which may serve as non-transitory computer-readable storage media storing processor-executable instructions for execution by the processor 1702.

### Additional Aspects

While several embodiments of the present technology have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present application.

More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the technology described herein. It is, therefore, to be understood that the foregoing embodiments are presented by way of example only and that, within the scope of the appended claims and equivalents thereto, the aspects of the technology may be practiced otherwise than as specifically described and claimed. The present application is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present application.

All definitions, as defined and used herein, should be understood to control over dictionary definitions, definitions in documents incorporated by reference, and/or ordinary meanings of the defined terms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1.-38. (canceled)

39. A method of detecting matter, in a medium, disposed proximate a surface of a sensor, the method comprising:
biasing a semiconductor channel of the sensor with an alternating current (AC) signal, the AC signal having a carrier frequency, based on an electrochemical interface between the medium and a surface of the sensor, and the AC signal further having a modulation frequency based on an electrical characteristic of the semiconductor channel;
measuring AC current flowing through the semiconductor channel of the sensor in response to biasing the semiconductor channel with the AC signal; and
determining, based on the AC current, a presence of matter, in the medium, disposed proximate the surface.

40. The method of claim 39, further comprising generating the AC signal by mixing a modulation signal having the modulation frequency with a carrier signal having the carrier frequency.

41. The method of claim 39, wherein the carrier frequency is above a high-pass cutoff frequency of the electrochemical interface that is based on a diffusion impedance and a double-layer capacitance of the electrochemical interface.

42. The method of claim 39, wherein the modulation frequency is below a threshold frequency of the semiconductor channel that is based on gate-to-channel leakage of the semiconductor channel.

43. The method of claim 39, wherein determining the presence of matter proximate the surface comprises determining, based on the AC current, a change in transconductance from a first transconductance without the matter present to a second transconductance with the matter present.

44. The method of claim 39, wherein determining the presence of matter proximate the surface comprises determining, based on the AC current, a change in capacitance from a first capacitance without the matter present to a second capacitance with the matter present.

45. The method of claim 44, wherein the change in capacitance is indicative of a change in dielectric constant at the surface of the sensor, and the change in dielectric constant at the surface of the sensor indicates the matter at the surface of the sensor.

46. The method of claim 45, wherein the sensor comprises a control stack comprising the surface and a dielectric layer between the surface and the semiconductor channel, and the change in dielectric constant is from a first dielectric constant of the control stack without the matter at the surface to a second dielectric constant of the control stack further including the matter present at the surface.

47. The method of claim 39, wherein the sensor further comprises a pair of channel terminals coupled to the semiconductor channel, and the AC current flows between the pair of channel terminals.

48.-49. (canceled)

50. The method of claim 39, wherein determining the presence of matter in the medium disposed proximate the surface comprises determining a presence of a species in the matter at the surface of the sensor.

51. The method of claim 48, wherein determining the presence of the species in the matter at the surface of the sensor comprises determining an amount of the species in the matter at the surface of the sensor.

52. The method of claim 51, wherein the capacitance indicates the amount of the species in the matter at the surface of the sensor.

53. The method of claim 52, wherein the capacitance indicates the amount of the species in the matter as bound to the surface of the sensor.

54.-65. (canceled)

66. A system, comprising:
a sensor, comprising:
a semiconductor channel; and
a surface; and
circuitry configured to:
while matter in a medium is disposed proximate the surface of the sensor, bias the semiconductor channel of the sensor with an alternating current (AC) signal, the AC signal having a carrier frequency, based on an electrochemical interface between the medium and the surface of the sensor, and the AC signal further having a modulation frequency based on an electrical characteristic of the semiconductor channel;
measure AC current flowing through the semiconductor channel of the sensor in response to biasing the semiconductor channel with the AC signal; and
determine, based on the AC current, a presence of matter, in the medium, disposed proximate the surface.

67. The system of claim 66, wherein the circuitry is further configured to generate the AC signal by mixing a modulation signal having the modulation frequency with a carrier signal having the carrier frequency.

68. The system of claim 66, wherein the carrier frequency is above a high-pass cutoff frequency of the electrochemical interface that is based on a diffusion impedance and a double-layer capacitance of the electrochemical interface.

69. The system of claim 66, wherein the modulation frequency is below a threshold frequency of the semiconductor channel that is based on gate-to-channel leakage of the semiconductor channel.

70. The system of claim 66, wherein the circuitry is configured to determine the presence of matter proximate the surface at least in part by determining, based on the AC current, a change in transconductance from a first transconductance without the matter present to a second transconductance with the matter present.

71. The system of claim 66, wherein the circuitry is configured to determine the presence of matter proximate the surface at least in part by determining, based on the AC current, a change in capacitance from a first capacitance without the matter present to a second capacitance with the matter present.

72. The system of claim 71, wherein the change in capacitance is indicative of a change in dielectric constant at the surface of the sensor, and the change in dielectric constant at the surface of the sensor indicates the matter at the surface of the sensor.

73. The system of claim 72, wherein the sensor comprises a control stack comprising the surface and a dielectric layer between the surface and the semiconductor channel, and the change in dielectric constant is from a first dielectric constant of the control stack without the matter at the surface to a second dielectric constant of the control stack further including the matter present at the surface.

74. The system of claim 66, wherein the sensor further comprises a pair of channel terminals coupled to the semiconductor channel, and the AC current flows between the pair of channel terminals.
